(19) United States
(12) Patent Application Publication
(10) Pub. No.: US 2002/0157267 A1
(43) Pub. Date: Oct. 31, 2002

(54) Device for longitudinally separating material strips by means of locking brakes on the cutter holders

(76) Inventors: Willi Bilstein, Overath (DE); Ingo Picker, Much (DE)

Correspondence Address: VENABLE, BAETJER, HOWARD AND CIVILETTI, LLP, P.O. BOX 34385, WASHINGTON, DC, 20043-9998, US

(21) Appl. No.: 09/959,851

(22) PCT Filed: Feb. 2, 2001
(86) PCT No.: PCT/EP01/01122

(30) Foreign Application Priority Data
Mar. 24, 2000 (DE) 100 14 827.1

(51) Int. Cl. B43L 13/02

(52) U.S. Cl. 33/41.4

(57) ABSTRACT

The invention relates to an apparatus for longitudinally dividing sheet material, said apparatus comprising a cutter bar (1) that is oriented crosswise to the movement direction of the sheet material and is provided with a guide (7) on which knife holders (2) are positioned such that they can be displaced. The knife holders are respectively provided with a immobilizing brake (18), comprising at least one movable brake block (18.1, 18.2), which acts via at least one force means (21) upon a parallel braking surface (20.1, 20.2), arranged so as to extend in longitudinal direction on the cutter bar. The force means is designed to immobilize the knife holder to be positioned ob the cutter bar (1) during the operation, wherein the force exerted by the brake block is oriented in the guide plane defined by the guide. The device is further provided with a positioning device (10) that is guided along the cutter bar (1) for positioning the individual knife holders (2). The positioning device comprises a coupling means (13) that can be activated and can be made to engage in the respective knife holder to be positioned and, upon engagement, releases the brake block (18.1, 18.2) of the immobilizing brake (18) from the braking surface (20.1, 20.2).

### DESCRIPTION

Apparatuses for longitudinally dividing sheet material are provided with a cutter bar that extends transverse to the movement direction of the sheet material and is provided with a plurality of knife holders, which are mounted such that they can be displaced and immobilized. For adjusting different cutting widths of the knife holders during a change in the cutting program, the immobilizing mechanism at each individual knife holder to be positioned must be released. The knife holder is then moved along the cutter bar to the new position where it must be adjusted once more and immobilized on the cutter bar. This does not present a problem with sheet material that must be divided into only a few partial widths.

However, changing the cutting program becomes difficult in cases where a wide material sheet must be divided into many narrow partial widths. The apparatus required for this not only is provided with a plurality of knife holders, but these must also be very narrow knife holders that are positioned closely together, depending on the cutting program. To facilitate the setting up of a new cutting program it is known to assign a separate, controllable device to the cutter bar for positioning the individual knife holders on the cutter bar. This controllable device is provided with a coupling element for respectively connecting a knife holder. In the process, an immobilizing brake is released and the knife holder is then moved with a controllable drive along the cutter bar. With the known positioning devices, the knife holder to be positioned is connected on one side only, so that tilting moments become effective, which are particularly disadvantageous for extremely narrow knife holders.

An apparatus for longitudinally dividing sheet material is known from German reference DE-U-2 980 301. This apparatus comprises a cutter bar with two parallel guides, on which knife holders are guided, such that they can be displaced and immobilized. A steel band that projects in the manner of a ridge is attached to the upper edge of the cutter bar and is respectively enclosed by a slotted recess in the individual knife holders. The individual knife holders are provided with a spring-loaded brake piston that can be moved back and forth perpendicular to the displacement plane defined by the two guides. The force effect of the spring is directed and dimensioned such that during the operation, it presses the brake piston from one side against the steel band, thus securing the knife holder during the operation in its predetermined position on the cutter bar.

An apparatus for longitudinally dividing sheet material is known from reference WO 97/31760, which also comprises two parallel guides. The knife holder of this arrangement also comprises a piston that can be moved transverse to the plane defined by the two guides and, with the aid of a spring, is pressed against a frictional area arranged between the two guides on the cutter bar. The knife holder is thus secured during the operation on the cutter bar.

The two embodiments comprise a positioning device that can be moved along the cutter bar and is provided with a finger-type coupling element, which can be moved transverse to the plane defined by the two guides. For the positioning, the coupling element is pushed forward toward the knife holder, so that it engages in a positive locking element on the knife holder and, at the same time, acts upon a pivoting lever connected to the brake piston. As a result, the brake piston is lifted off the associated braking surface on the steel band and on the cutter bar. Both embodiments have the disadvantage that owing to the braking force as well as the force for releasing the immobilizing brakes, the knife holder bearings on the guides of the cutter bar, which are designed as linear guidance systems with recirculating linear ball bearings, are stressed by considerable lateral forces.

Thus, it is the object of the invention to design an apparatus of this type in such a way that the respective knife holder to be positioned can be displaced and immobilized on the cutter bar, virtually without lateral forces.

This object is solved according to the invention with an apparatus for longitudinally dividing sheet material, comprising a cutter bar that extends transverse to the movement direction of the sheet material and is provided with a guide on which knife holders are positioned such that they can be displaced. The knife holders are respectively provided with an immobilizing brake with at least one movable brake block, which acts via a force means upon a parallel braking surface extending in longitudinal direction along the cutter bar, so as to immobilize the knife holder during the operation. The force effect of the brake block is oriented in the guide plane defined by the guide. The object is furthermore solved with a positioning device, guided along the cutter bar for positioning the individual knife holders. The positioning device comprises a coupling means that can be activated and made to engage in the respective knife holder to be positioned and, in case of an engagement, releases the brake block of the immobilizing brake from the braking surface. The guide surface is essentially defined by the front surface of the cutter bar, which faces the knife holders. Thus, it is ensured that the contact pressure of the brake block essentially acts upon the guide in the same direction as the operating load of the knife holder.

A particularly advantageous embodiment of the invention provides that the coupling means is designed as tong-type gripper that extends from the back across the cutter bar and grips the knife holder to be positioned from above and below, thereby acting upon the adjustment means connected to the brake block. As a result, two spaced-apart coupling points exist, which accordingly lead to an exact parallel guidance of the knife holder on the cutter bar. The guides between the knife holder and the cutter bar consequently are not stressed through tilting and effective tilting moments can be absorbed solely via the much larger dimensioned guide path of the positioning device. The forces that must be generated for releasing the brake block are then absorbed exclusively between the gripper elements with tong-like movement by the positioning device. This design permits using force means with a high braking force since the forces for releasing the brake block can be absorbed by the grippers without stressing the guide, owing to the counter-directed movement of the two grippers. It is also possible to assign the force means, e.g. a correspondingly dimensioned spring, directly to the brake block. Given an arrangement with two separate, parallel guides for the knife holders on the cutter bar, it is advantageous if the force exerted by the brake block is effective in the plane for the two guides and crosswise to its extension.

Another advantageous embodiment of the invention provides that the guides for the knife holders are provided with at least one side wall that is designed as braking surface. As a result, an additional structural component can be saved.

A ridge arranged on the guide beam can also form the braking surfaces of one embodiment according to the invention.

At least one spring is advantageously used as force means, which acts upon the brake blocks so as to close them. Depending on the embodiment, the brake block can be positioned such that it can be moved or pivoted.

It is particularly advantageous if an apparatus for longitudinally dividing sheet material is provided with two opposite directed brake blocks that can be moved toward each other and respectively act upon an associated braking surface, wherein the force effect of the brake block is oriented in the guide plane. The arrangement of opposite directed brake blocks has the advantage that the individual knife holders are not subjected on one side only to the braking forces and the forces acting upon them when the brake blocks are released. As a result, it is possible to practically keep away all forces from the bearings of the knife holders in their guides on the cutter bar. The guides between knife holders and cutter bar thus also cannot be stressed through tilting. Given a corresponding positioning of the brake blocks on the knife holder, the two brake blocks can thus also be positioned floating and transverse to the movement direction of the knife holder. However, it is advantageous if the knife holder in the predetermined position is secured without play and transverse to its movement direction.

The arrangement of brake blocks moving in opposite directions, however, is also advantageous and useful for arrangements based on the initially mentioned prior art since the force effect between the two brake blocks can thus be kept away from the guides.

The invention is explained in further detail with the aid of schematic drawings of exemplary embodiments. Shown are in:

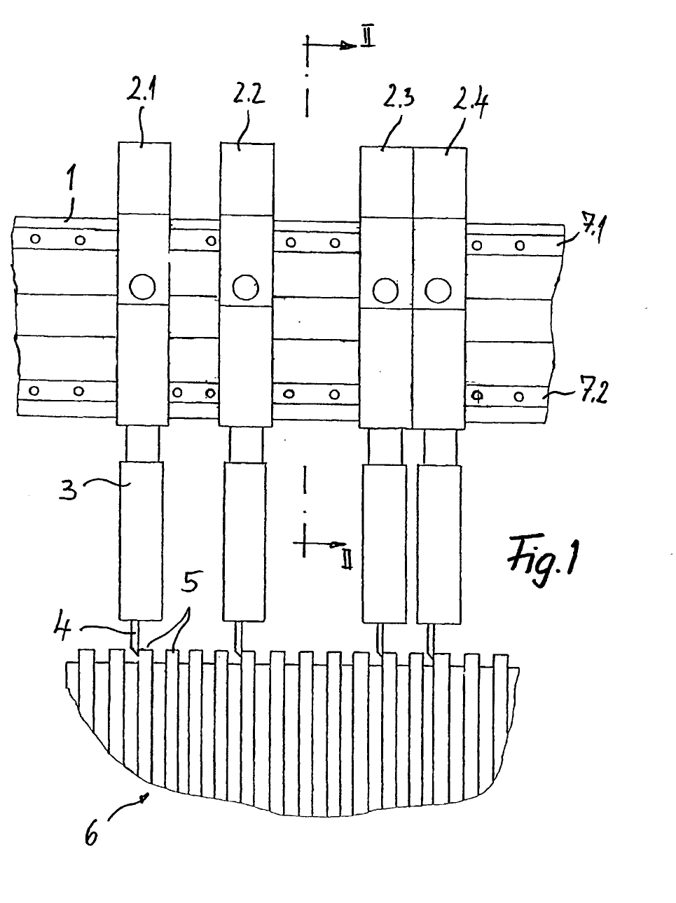

FIG. 1 A frontal view of details of an apparatus for longitudinally dividing sheet material.

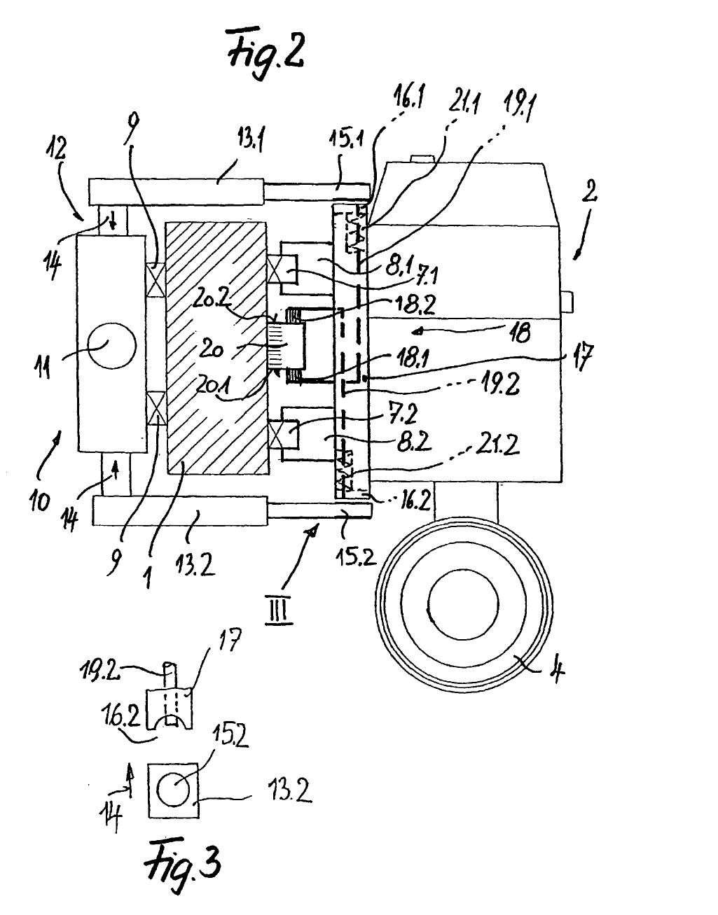

FIG. 2 A view from the side, shown as a section along the line II-II in FIG. 1, with opposite directed brake blocks that can be moved toward each other.

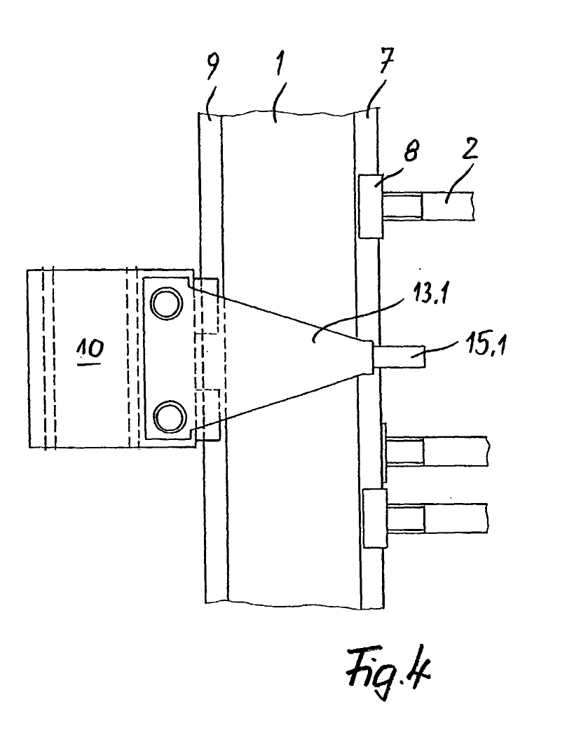

FIG. 3 A frontal view of detail III in FIG. 2, seen on a larger scale.

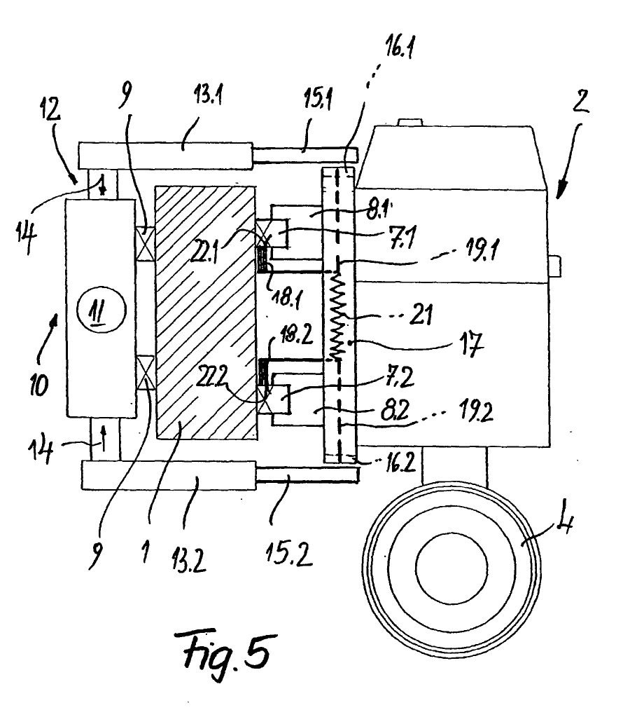

FIG. 4 A view from above of the arrangement according to FIG. 3.

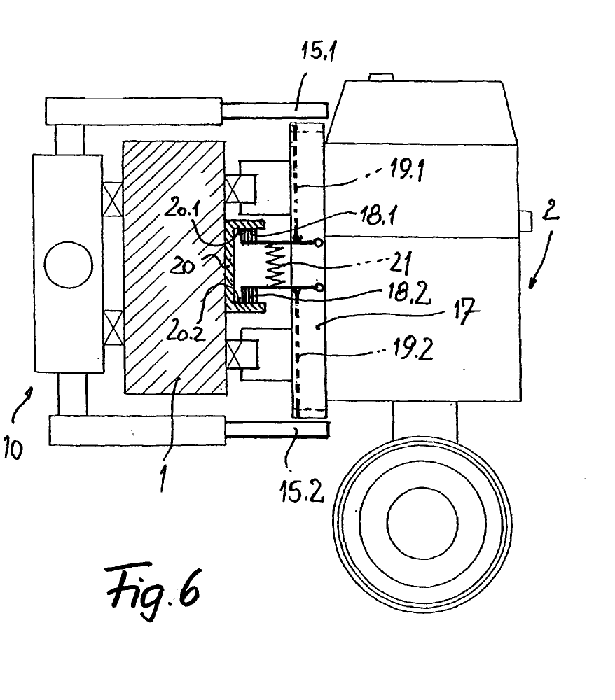

FIG. 5 A modified embodiment according to FIG. 2, in a view from the side.

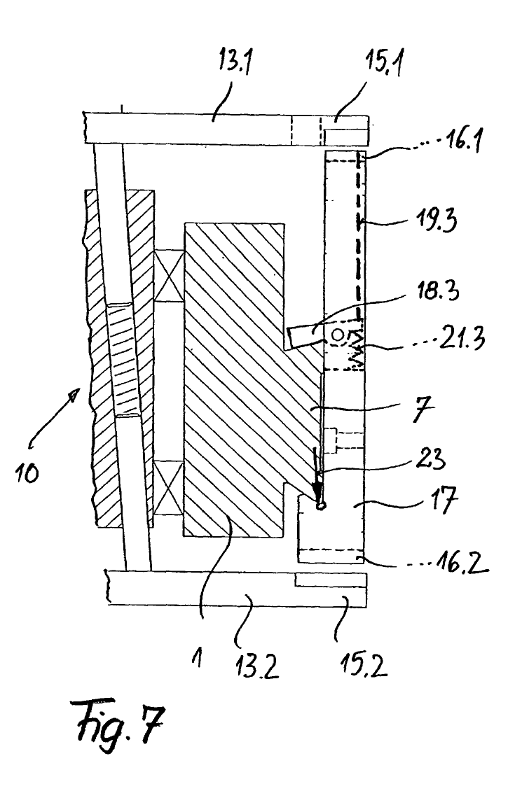

FIG. 6 An embodiment according to FIG. 2 with opposite directed brake blocks that can be pivoted toward each other.

FIG. 7 An embodiment with prism guide and only one brake block.

The detailed views of the apparatus for longitudinally dividing sheet material, illustrated in FIG. 1, show that the apparatus comprises a cutter bar 1 that extends transverse to the movement direction of a material width to be divided. The cutter bar contains several knife holders 2, arranged side-by-side such that they can be displaced and immobilized. The knife holders 2 are each provided with a knife head 3, which is held crosswise and parallel to the orientation of the cutter bar 1 on the knife holder 2, such that it can be moved by means of an adjustment drive, and is provided with a circular knife 4. In the cutting position shown herein, the circular knife 4 is operatively connected to a counter blade 5, which is attached to a knife shaft 6. A plurality of counter blades 5 are attached to the knife shaft 6 with a predetermined spacing, as shown in FIG. 1, to realize the greatest variety of cutting programs. Different cutting programs can thus be realized by adjusting the spacing between neighboring knife holders. However, it is also possible to provide knife holders with corresponding counter blades, e.g. keyway cutter bars, which are mounted on a respective additional cutter bar, such that they can be displaced and immobilized.

In FIG. 1, the knife holders 2.1 and 2.2 are immobilized at a distance to each other on the cutter bar 1, such that a relatively wide strip of material can be cut. The right side of the drawing shows two closely adjoining knife holders 2.3 and 2.4, which permit the narrowest possible cutting width for an existing apparatus for longitudinally dividing material.

With the exemplary embodiment shown in FIG. 1, the cutter bar 1 is provided with guides 7.1 and 7.2, to which corresponding ball-bearing guides 8.1 and 8.2 are assigned on the individual knife holders 2.1, 2.2, 2.3 and 2.4 because the guides 7 overlap in a U shape (compare FIG. 2). The guides 7 with associated ball-bearing guides 8, shown herein only schematically as a structural unit, are designed such that the knife holder is connected form-locking with the cutter bar 1 and can be moved only in longitudinal direction of the cutter bar 1. During the operation, the individual knife holders 2 on the cutter bar 1 are respectively secured with an immobilizing brake, which is explained in further detail in the following. A plane that connects the two guides 7.1 and 7.2 defines a so-called guide plane for the knife holders 2.

If the cutting program is to be changed, the individual knife holders with their spacing relative to each other must be repositioned on the cutter bar 1. The simplified illustration in FIG. 2 shows that in order to facilitate the positioning operation, a positioning device 10, also called a “positioning locomotive,” can be moved on its own guide path 9, for example designed as ball bearing guide, in longitudinal direction along the cutter 1. The positioning device 10 generally is connected to an adjustment drive 11, which is only indicated schematically herein. Thus, the positioning device 10 can be controllably moved along the cutter bar 1.

The positioning device 10 is provided with a tong-type gripper 12 that has two gripper fingers 13.1 and 13.2, which grip around the cutter bar 1 from above and below. By means of a corresponding adjustment drive, the two gripper fingers 13.1 and 13.2 can be moved toward each other from the open position, shown herein, in the direction of arrows 14. Thus, they can engage with their finger ends 15.1 and 15.2 in corresponding recesses 16.1 and 16.2 on the knife holder 2 or an adapter slide 17 that is connected to the knife holder 2. With the embodiment shown, the knife holders 2 can respectively be released from the adapter slide and can be replaced while the adapter slide 17 remains on the cutter bar. The knife holder 2 and the adapter slide 17 form a single unit during the operation, which is also moved as one unit for the positioning. The knife holders 2 furthermore are immobilized during the operation in the cutting position with the aid of an immobilizing brake 18 on the cutter bar 1, which is integrated into the knife holder 2 or, as shown herein, in the adapter slide 17. This immobilizing brake 18 is designed such that it is released each time the finger ends 15 of the gripper fingers 13 engage. Design and function of the immobilizing brake 18 are explained in further detail in the following.

As soon as the knife holder 2 to be positioned reaches its new end position on the cutter bar 1, the adjustment drive of the tong-type gripper 12 is deactivated, so that the gripper fingers 13 are released from the knife holder 2 and the immobilizing brake 18 immobilizes the knife holder 2 for the operation in the final position on the cutter bar 1.

The frontal view in FIG. 3 shows the detail III in FIG. 2 with the gripper finger 13.2 and its finger end 15.2, as well as the recess 16.2 on the adapter slide 17. The top section is designed in the same way. FIGS. 2 and 3 show that when the tong-type gripper is closed, the knife holder 2 is held form-locking from above and below and can be moved without tilting or twisting when the positioning device 10 is moved along its guides 9 on the cutter bar 1.

FIG. 4 shows a view from above of an arrangement according to FIGS. 1 and 2. No further explanations are required because the same structural elements are given the same reference numbers.

The embodiment of an immobilizing brake 18, shown schematically in FIG. 2, essentially consists of two brake blocks 18.1 and 18.2. For the exemplary embodiment shown herein, the opposite directed brake blocks are positioned inside the adapter slide 17, such that they can be moved toward each other. The movement direction for the two brake blocks 18.1 and 18.2 is in the guide plane defined by the two guides 7.1 and 7.2. The brake blocks 18.1 and 18.2 are respectively attached to connecting rods 19.1 and 19.2, which extend on the adapter slide 17 up to the recesses 16.1 or 16.2, meaning to the area of engagement for the finger ends 15 of the associated gripper fingers 13. The brake blocks in this case fit against brake surfaces 20.1 and 20.2 of a brake beam 20, which is mounted between the two guides 7 on the cutter bar 1. The compression forces that cause the braking forces are applied with the aid of force means 21.1 and 21.2, for example compression springs, which are designed to reliably secure the adapter slide 17 with the attached knife holders 2 in movement direction, against the forces generated during the operation.

If respectively one knife holder is to be displaced, the positioning device is moved against the knife holder to be displaced. The two gripper fingers 13.1 and 13.2 are moved relative to each other with the adjustment drive, as described in the above. FIG. 3 indicates that when the finger ends 15 engage in the recesses 16, the free ends of the connecting rods 19.1 and 19.2 push down against the force of the spring elements 21.1 and 21.2. As a result, the connected brake blocks 18.1 and 18.2 are released from the associated braking surfaces 20.1 and 20.2. The knife holder 2 can be moved with the positioning device 10 along the cutter bar 1 to its new position. As soon as the tong-type gripper 12 opens up and the finger ends 15 are moved out of the recesses 16, the brake blocks 18.1 and 18.2 also make contact with their brake surfaces 20.1 and 20.2, so that the knife holder is locked in place in its new position.

FIG. 5 shows a modified embodiment where the side surfaces 22.1 and 22.2 of the guides 7 that are fixedly connected to the cutter bar serve as braking surfaces in place of a brake beam 20. With the exemplary embodiment shown herein, the side surfaces 22 of guides 7 that face each other are designed as braking surfaces. Thus, the opposite directed brake blocks 18.1 and 18.2 that can be moved toward each other can respectively make contact in the adapter slide 17, e.g. under the force effect of a compression spring 21. The brake blocks 18.1 and 18.2 in this case are also guided with a connecting rod 19.1 and 19.2 inside the adapter slide 17, wherein the free ends of the connecting rod 19.1 and 19.2 are again removed from the region of recesses 16. When the tong-type gripper 12 closes in the manner as described in the above, the two brake blocks 18.1 and 18.2 are lifted off the side surfaces 22 or the guides 7. The knife holder can thus be moved to a new position on the cutter bar 1 via its adapter slide 17 and, if the tong-type gripper 12 opens up, can again be secured in the predetermined position by means of the brake blocks 18.1 and 18.2.

The embodiment shown in FIG. 5 has the advantage that both brake blocks 18.1 and 18.2 are pushed with the same braking force against the braking surfaces on the guides 7 via the spring 21 that is effective between both brake blocks 18.1 and 18.2.

As shown, the brake blocks 18.1 and 18.2 can be positioned displaceable in the adapter slide 17 or in the knife holder 2 if this knife holder is immobilized directly on the cutter bar. In a modification, the brake blocks can also be positioned pivoting or can be designed as tong-type grippers.

The embodiment shown in FIG. 6 is modified as compared to the one shown in FIG. 2. The brake blocks 18.1 and 18.2 are positioned pivoting on the adapter slide 17 and make contact with the inside surfaces, functioning as braking surfaces 20.1 and 20.2, of a brake beam 20 with U-shaped cross section. The brake blocks 18.1 and 18.2 are pressed against the braking surfaces with a compression spring 21 as force means. With the aid of connecting rods 19.1 and 19.2, the brake blocks can subsequently be released via the finger ends 15.1 and 15.2, as described in the above.

It is easy to see from the above-described exemplary embodiments of an immobilizing brake with two brake blocks, shown in the drawings, that the immobilizing brake 18 according to the invention, which otherwise has an identical design, can also be realized with only one brake block. The force effect of a single brake block furthermore also extends in the guide plane, which essentially corresponds to the main load plane for the guides 7/8.

FIG. 7 shows an embodiment of an apparatus for longitudinally dividing sheet material, which comprises a clamping strip with dove-tailed cross section as guide 7 for fastening the knife holders on the cutter bar 1. The knife holders are provided with a holding part or adapter 17 (only the holding part 17 is shown herein) that is provided with a pivoting brake block 18.3. Thus, the brake block 18.3 can be pressed via a compression spring 21.3 that is also positioned on the holding part 17 against the clamping strip and the knife holder can be immobilized on the cutter bar 1. Knife holders of this type basically can be moved only with a high force expenditure due to the high friction between the clamping strip and the¹, even with released brake block 18.3 because of the high force expenditure. ¹Note: This sentence is incomplete.

If the gripper fingers 13.1 and 13.2 are guided such that they can be displaced parallel to each other, but such that they are guided at an acute angle crosswise to the longitudinal extension of the cutter bar 1, as shown in FIG. 7, then a knife holder or adapter that is fastened with a dove-tailed clamping strip on the cutter bar 1 can also be displaced with the aid of a positioning device.

For the actuation, the two gripper fingers 13.1 and 13.2 are moved toward each other via the adjustment drive of the positioning device, until they engage form-locking with the finger ends 15.1 and 15.2 in the corresponding recesses 16.1 and 16.2 of holding part 17. In the process, the brake block 18.3 is released via the connecting rod 19.3, so that the clamping is removed and a certain amount of play is created in the form-locking connection between the holding part 17 of the knife holder to be positioned and the clamping strip. The tong-type gripper is then lowered down to a non-depicted supporting spring, so that the holding part 17 is lifted off the dove-tailed clamping strip in the direction of arrow 23, corresponding to the inclination of the guide for the two gripper fingers 13.1 and 13.2 of the knife holder to be positioned. The holding part is lifted off in the front as well as on the lower, slanted flanks of the clamping strip, so that a corresponding clearance space develops between the clamping strip and the knife holder to be positioned. Since the knife holder to be positioned via the positioning device 10 is now supported by its guides 9 on the cutter bar, the knife holder can be displaced and newly positioned without contact on the cutter bar 1, even with this type of connection between cutter bar and knife holder. If the form-locking connection with the finger ends 15.1 and 15.2 is released once more, the pressing spring 21.3 presses the brake block 18.3 once more against the clamping strip and the knife holder is locked in place in its new position.

In principle, it is possible to activate the immobilizing brake according to the invention with other means than the ones described in the above. The above-described embodiments have the advantage that the forces for releasing the immobilizing brake are absorbed by the gripper fingers of the positioning device and do not stress the guides. Thus, it is possible to use springs with a high spring force.

1. An apparatus for longitudinally dividing sheet material, comprising a cutter bar (1) that is aligned transverse to the movement direction of the sheet material and is provided with a guide (7) on which knife holders (2) are positioned so as to be displaceable, said knife holders being respectively provided with an immobilizing brake (18) with at least one movable brake block (18.1, 18.2) that acts via at least one force means (21) upon a braking surface (20.1, 20.2), extending parallel to its longitudinal direction and immobilizes the knife holder to be positioned during the operation on the cutter bar (1), wherein the force effect of the brake block is oriented in the guide plane defined by the guide, said device further having a positioning device (10) guided on the cutter bar (1) for positioning the individual knife holders (2), which device comprises a coupling means (13) that can be actuated and can be made to engage with the respective knife holder to be positioned and, once it is engaged, releases the brake block (18.1, 18.2) of the immobilizing brake (18) from the braking surface (20.1, 20.2).

2. An apparatus according to claim 1, characterized in that respectively two parallel guides (7) are arranged on the cutter bar (1) for the knife holders (2) and that the force effect of the brake block (18.1, 18.2) is directed in the plane of the two guides and crosswise to the extension toward the braking surface (20.1, 20.2).

3. An apparatus according to one of the claims 1 to 3, characterized in that the braking surface (20.1, 20.2) is a brake beam (20) that is arranged on the cutter bar (1).

4. An apparatus according to one of the claims 1 to 3, characterized in that the guide (7) for the knife holders has at least one side wall that functions as braking surface (22.1, 22.2).

5. An apparatus according to one of the claims 1 to 4, characterized in that the coupling means is designed as tong-type gripper (12, 13), which extends from the back over the cutter bar (1) and grips the knife holder (2) to be positioned from above and below its guides (7), thus acting upon adjustment means (19) that are connected to the brake block (18.1, 18.2).

6. An apparatus according to one of the claims 1 to 5, characterized in that at least one spring functions as the force means (21), which acts upon the brake block (18.1, 18.2), so as to close it.

7. An apparatus according to one of the claims 1 to 6, characterized in that the brake block (18.1, 18.2) is positioned such that it can be displaced.

8. An apparatus according to one of the claims 1 to 7, characterized in that the brake block (18.1, 18.2; 18.3) is positioned such that it can pivot.

9. An apparatus, in particular according to one of the claims 1 to 8, characterized in that two opposite directed brake blocks (18.1, 18.2) are provided, which can be moved toward each other and act upon respectively one associated braking surface (22).
